(19) United States
(12) Patent Application Publication
(10) Pub. No.: US 2026/0067694 A1
(43) Pub. Date: Mar. 5, 2026

(54) SECURE MOBILE NETWORKING USING ADVANCED DNS

(71) Applicant: T-MOBILE INNOVATIONS LLC, Overland Park, KS (US)

(72) Inventors: Geoffrey Todd GIBSON, Ben Wheeler, TX (US); Jeffrey Scott SIMON, JR., Issaquah, WA (US)

(21) Appl. No.: 18/816,977

(22) Filed: Aug. 27, 2024

(51) Int. Cl. H04W 12/121; H04L 61/4511; H04L 67/02

(52) U.S. Cl. CPC H04W 12/121; H04L 61/4511; H04L 67/02

(57) ABSTRACT

Embodiments of the present disclosure are directed to systems and methods for providing secure network communications, the system comprising a telecommunication network communicatively coupled to a user device, and one or more processors communicatively coupled to the telecommunication network, the one or more processors being configured to, receive a domain name system query from the user computing device, determine that the user computing device is associated with an Oblivious DNS Over HTTPS (ODOH) indicator, and cause transmission of the domain name system query through an ODOH specific slice of the plurality of network slices.

### SUMMARY

The present disclosure is directed to systems and methods for secure mobile networking using advanced DNS.

According to various aspects of the technology, a user computing device associated with a telecommunication network comprised of a plurality of network slices may generate a domain name system (DNS) query. It may be determined that the user computing device making the query is associated with an Oblivious DNS Over HTTPS (ODoH) indicator. Based on this determination, the DNS query is transmitted through an ODoH specific slice of the plurality of networks. Additionally or alternatively, the telecommunication network may be comprised of a single network slice which may generate a domain name system (DNS) query. In embodiments, it may be determined that the user computing device making the query utilizing the single network slice may be associated with an ODoH indicator, and based on this determination, the DNS query is transmitted utilizing ODoH.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example of a computer environment, in accordance with one or more embodiments;

FIG. 2 depicts a diagram of a network environment, in accordance with one or more embodiments;

FIG. 3 is a flow chart of a method for network communication, in accordance with one or more embodiments;

FIG. 4 is a flow chart of an additional or alternative method for network communication, in accordance with one or more embodiments;

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “network address transmation (NAT)” is synonymous with wireless communication protocol and is an umbrella term used to refer to the particular technological standard/protocol that governs the communication between a UE (User Equipment) and a base station; examples of network access technologies include 3G, 4G, 5G, 6G, 802.11x, and the like. The term “node” is used to refer to an access point that transmits signals to a UE and receives signals from the UE in order to allow the UE to connect to a broader data or cellular network (including by way of one or more intermediary networks, gateways, or the like)

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, when a user seeks to connect to a website through the use of an application such as a web browser, the user device may make a DNS query. Alone, a DNS query is not encrypted and may leave private information open to the public. As such, DNS queries constitute a privacy concern for many users. One method of obfuscating the private information of a DNS query is through the use of Oblivious DNS over HTTPS (ODoH) which is a privacy-enhancing technology designed to safeguard users' DNS queries from potential eavesdroppers and prevent a mobile network operator (MNO), communications service provider (CSP), etc. from mapping DNS queries to a specific user. Traditional DNS queries, even when encrypted using DNS over HTTPS (DoH), reveal the domain names being requested this allows the potential logging or misuse this information. ODoH addresses this issue by adding a layer of obfuscation to the process. ODoH does this by obfuscating the DNS queries through the use of a proxy, ensuring that the identity of the user device making the request is obfuscated. When a user initiates a DNS query, it is first encrypted and sent to a proxy, which then forwards it to the DNS resolver.

Conventionally, ODoH processes are handled by third party devices or application which a user must actively enable on each individual device or each individual web browser. Once enabled, the DNS query is obfuscated by the third party devices/application such that the internet protocol (IP) address of the originating device is obfuscated. The DNS query is then forwarded to a resolver which processes the request and sends the response back through the proxy, which in turn sends it back to the user device. This ensures that the query cannot be linked to the user device, enhancing user privacy. Conventional solutions require the use of third party software such as web browsers or software associated with a particular operating system. These ODoH solutions require that a user manually activate the ODoH software in order to ensure that the DNS queries are properly encrypted through the use of ODoH

Unlike conventional solutions, the invention recited herein describes a telecommunication network implementation of ODoH such that third party software, either on browser, or otherwise are not necessary. As described above ODoH queries require an extra level of obfuscation which needs additional computing resources and processing times to accomplish. These ODoH queries, particularly when at a high quantity can bog down the processing resources and latency of networks. When implemented at the level of a 5G network, ODoH queries may be transmitted utilizing an ODoH specific slice of the 5G network. It may be determined which user computing devices are associated with an ODoH request or ODoH indicator and based on this determination, transmit said ODoH requests over the ODoH specific slice of the 5G network. The ODoH specific slice may also be associated with a carrier or network address translation (NAT) device which handles the obfuscation of the IP address of the ODoH queries. It is important to note that 5G networks may be used for many different forms of data transmission. Some of these forms of data transmission require incredibly low latency, such as self-driving cars or any other data transmissions requiring a low latency environment. Instead of impacting the latency of other DNS related communications, a unique ODoH specific slice may be used to handle these ODoH queries. A MNO may handle ODoH queries in a dedicated network slice which may allow for more efficient management and routing of the ODoH traffic in a 5G network.

Accordingly, a first aspect of the present disclosure is directed to a computerized method for providing secure network communications, the method comprising receiving a DNS query from a user computing device associated with a telecommunication network. The method further comprising determining that the user computing device is associated with an ODoH indicator, and causing transmission of the DNS query through an ODoH specific proxy which may be transmitted over a dedicated network slice.

A second aspect of the present disclosure is directed to computer-readable storage media having computer-executable instructions embodied thereon that, when executed by one or more processors, cause the one or more processors to determine that a user computing device is associated with an ODoH indicator. The one or more processors are further configured to cause transmission of a DNS query from the user computing device through an ODoH specific slice of a plurality of network slices.

Another aspect of the present disclosure is directed to a system for providing secure network communications, the system comprising a telecommunication network communicatively coupled to a user device, and one or more processors communicatively coupled to the telecommunication network, the one or more processors configured to receive a DNS query from the user computing device. The one or more processors further configured to determine that the user computing device is associated with an ODoH indicator, and cause transmission of the DNS query through an ODoH specific slice of the plurality of network slices.

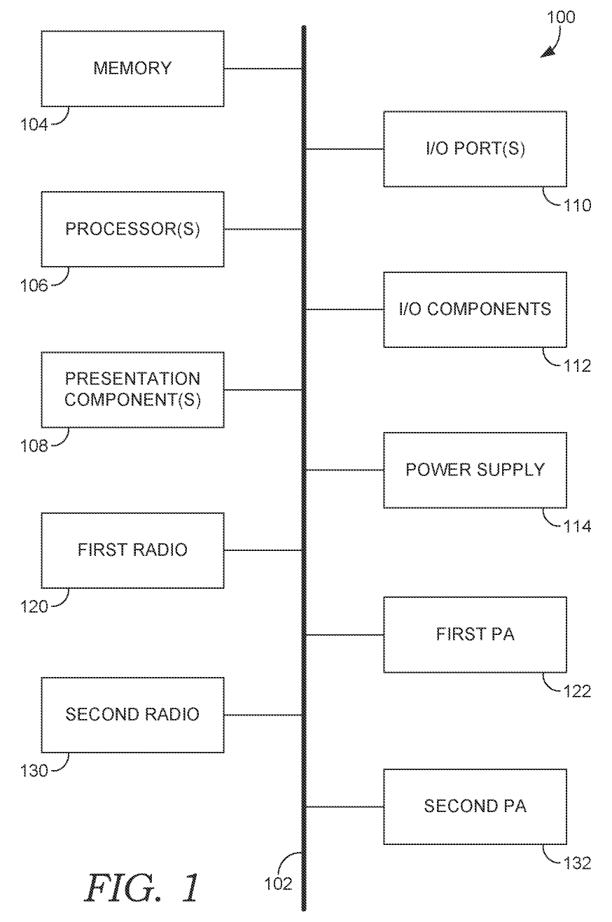

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to a an access point and receive one or more signals from the access point (or some other access point); the computing device 100 may be referred to herein as a user equipment, wireless communication device, or user device, The computing device 100 may take many forms; non-limiting examples of the computing device 100 include a cell phone, tablet, internet of things (IoT) device, smart appliance, automotive or aircraft component, unmanned aerial vehicles, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate with a wireless network on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, 6G, VoLTE, or other VoIP communications. In aspects, the first radio 120 and the second radio 130 may be configured to communicate using the same protocol but in other aspects they may be configure dot communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies.

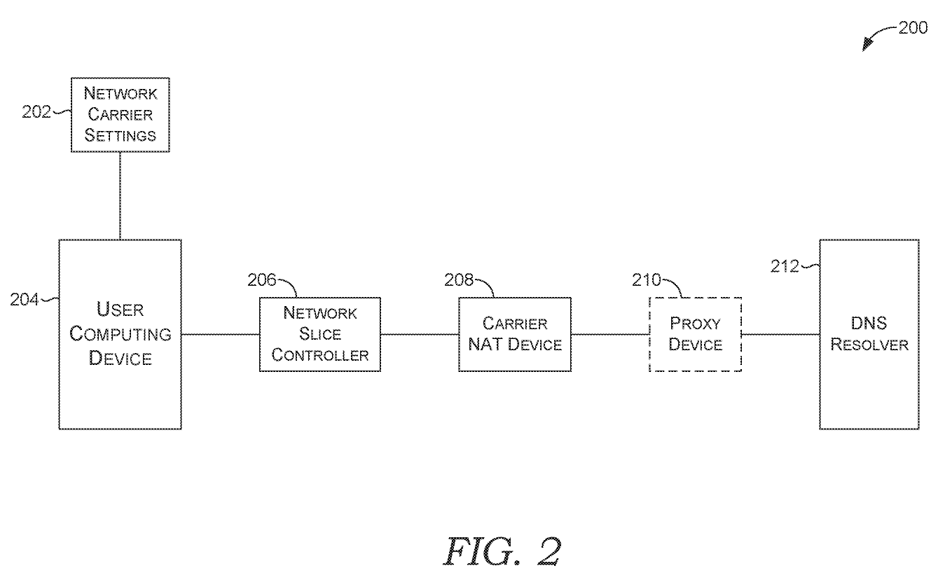

FIG. 2 depicts an example of a network environment 200, in accordance with one or more embodiments. By way of a high level example, the network environment 200 may be a 5G telecommunication network capable of handling DNS queries. In an embodiment, any number of user computing devices 204 may be associated with a set of network carrier settings 202 which may indicate whether the user computing devices 204 are associated with a DOH indicator or an ODOH indicator. In embodiments, the DoH indicator or ODoH indicator may be anything which indicates that a user computing device or service is associated with either Oblivious DNS Over HTTPS or DNS Over HTTPS. For example, the DoH indicator or ODoH indicator may be an attribute in a subscriber account profile associated with the user computing device which indicates that the service a user has selected utilizes ODoH, may be an attribute associated with a user or a user computing device which indicates that the user or user computing device has selected to opt in to use ODoH or DoH, or an indicator associated with the carrier which indicates that a user or user computing device has been selected for either ODoH or DoH. For example, certain business types or certain organizations may have their communications associated with an ODoH indicator such that their communications are transmitted utilizing the ODoH slice. A network slice controller 206, such as a Network Slice Selection Function (NSSF), of the telecommunication network may generate at least one DoH specific slice and one ODoH specific slice. In embodiments, a user computing device 204 associated with an ODoH indicator will have communications transmitted over the ODoH specific slice which shall automatically apply a hide NAT by a Carrier NAT Device 208. In additional or alternative embodiments, a user computing device 204 associated with a DoH indicator may be transmitted utilizing the DoH specific slice which does not apply a hide NAT to the DNS query.

Moving to a discussion of each feature of FIG. 2, the network environment 200 may be any telecommunication network capable of transmitting data utilizing a 5G network. The network environment 200 may additionally or alternatively include a set of network carrier settings 202. These network carrier settings 202 may comprise a set of DNS configurations associated with DoH or ODoH configurations. These network carrier settings 202 may be transmitted to or received by any number of user computing devices 204 associated with a telecommunication network. In embodiments, the network carrier settings 202 may indicate any number of user computing devices 204 which are associated with either a DoH indicator or an ODoH indicator. The ODoH indicator may be any form of identifier such as machine readable code which indicates that a particular user device is associated with a request for ODoH queries. As such, the network may identify for which devices to use ODoH queries rather than DoH queries. The ODoH indicator may be an indicator which a user of a user computing device 204 activates either through the user of the operating software of a user computing device 204, or by selecting an ODoH option in their carrier network settings. In additional or alternative embodiments, the ODoH indicator may be an option that any user of a telecommunication network may select in order to enable the use of ODoH when making DNS queries. In additional or alternative embodiments, all user computing devices associated with a telecommunication network, or a portion of a telecommunication network may be default associated with an ODoH indicator, or may be default associated with a DoH indicator. These network carrier settings 202 may be used in determining which slice is utilized, including the default slice, when sending various communications from user computing device 204 across a 5G network. In embodiments, the user computing devices 204 may be a computing device such as computing device 100. The user computing device 204 may additionally or alternatively be any device capable of making a DNS query utilizing a 5G telecommunication network.

In embodiments, the network environment 200 comprises at least a network slice controller 206 that enables network slicing and the creation of multiple virtual networks or slices on a shared physical infrastructure. For example, the network slice controller 206 may generate a slice for handling DoH queries and a separate slice for handling ODoH queries. As ODoH queries require additional elements in order to remain oblivious, the network slice controller 206 may assign additional computing resources and/or bandwidth to the ODoH specific slice. Further, the network slice controller 206 may designate fewer computing resources and a lower bandwidth to the DoH specific slice. In additional or alternative embodiments, more user computing devices 204 may be associated with a DoH indicator than an ODoH indicator. In said embodiment, the network slice controller 206 may designate more bandwidth to the DoH specific slice in order to handle the larger quantity of user computing devices 204 making DoH queries or vice versa. By utilizing unique slices for handling either DoH or ODoH queries, the telecommunication network may more efficiently utilize network resources. For example, data transmissions that require very low latencies may be handled by either the DoH specific slice, or a slice distinct from either the DoH specific slice or the ODoH specific slice. This embodiment avoids impacting the latency where low latency is needed, by carving out a slice and needed network resources for specifically handling ODoH queries. This allows a telecommunication network to provide broad ranging ODoH queries at a network level for any number of user computing devices 204 without negatively impacting other slices or other services provided by the telecommunication network.

Continuing the discussion of FIG. 2, in additional or alternative embodiments, the network environment 200 may comprise a Carrier NAT Device 208 or a Proxy Device 210 which may be software or hardware associated with the network carrier such as any telecommunication network capable of transmitting data utilizing a 5G network. The Carrier NAT Device 208 or Proxy Device 210 shall apply a hide NAT rule or policy to a source IP of any user computing device 204 such that the original IP address of the user computing device 204 converted to a new IP address to hide the original IP address. The Carrier NAT Device 208 may transmit queries through only the ODoH specific slice, such that the Carrier NAT Device 208 only applies hide NAT to queries transmitted through the ODoH specific slice. In embodiments, any DNS query transmitted across the ODoH specific slice automatically has a hide NAT applied to it by the carrier nat device 208. This allows the transformation of a standard DoH query into an ODoH query utilizing the carrier nat device 208 to apply a Hide NAT applied to the IP address of the originating user computing device 204. In additional or alternative embodiments, this carrier nat device 208 may be associated with any portion of a telecommunication network architecture such as any number of edge computing devices.

The network environment 200 also includes a DNS resolver 212 and may include a proxy device 210. In embodiments, the DNS Resolver 212 may provide termination of the HTTPS request and decryption of the data communicated from the user computing device 204. In additional or alternative embodiments, the proxy device 210 may be optional and the functions of the proxy device may be handled by the DNS resolver 212. In addition to potentially handling the functions of the proxy device 210, the DNS resolver 212 may resolve the DNS query, whether ODoH or DoH and return a response to the user computing device 204.

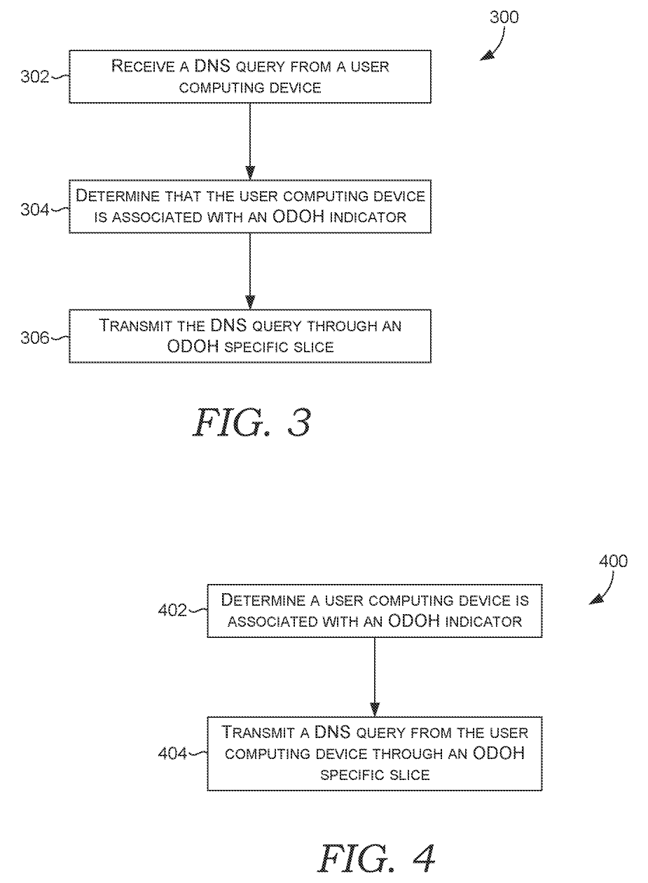

Turning now to FIG. 3 a flow chart is provided for a method 300 for providing network communications. At a first step 302, a DNS query is received from a user computing device associated with a telecommunication network comprised of a plurality of network slices. In embodiments, the telecommunication network may be any 5G network capable of generating and transmitting data over distinct network slices. At a second step 304, it is determined that the user computing device is associated with an ODoH indicator. The ODoH indicator may be a set of network carrier settings such as network carrier settings 202 which indicate that DNS queries transmitted by the user computing device are to be handled as an ODoH query which requires additional processing over a standard DoH query.

At a third step 306, the DNS query is caused to transmit through an ODoH specific slice of the plurality of network slices. In embodiments, the network slices of the telecommunication network may be generated or terminated by a network slice controller such as the network slice controller 206 of FIG. 2. A network slice controller may generate any number of slices prior to or in response to any number of carrier network settings. For example, a 5G telecommunication network may have a pre-set ODoH specific slice, including the default slice, which handles ODoH queries, or an ODoH specific slice, slice other than the default slice, may be generated by a network slice controller in response to determining a threshold number of user devices associated with ODoH indicator are connected to any portion of the network. In embodiments, the ODoH queries will be transmitted utilizing the ODoH such that the DNS query remains oblivious. In embodiments, the ODoH specific slice is configured to transmit DNS queries to a NAT device such as the carrier NAT device 208 or Proxy Device 210 discussed in relation to FIG. 2 which is configured to update an internet protocol address of the user computing device. For example, the carrier NAT device may apply a hide NAT to the DNS query in order to hide the IP address associated with the originating user computing device. In embodiments, the NAT device may be an edge device of the telecommunication network. In additional or alternative embodiments, the ODoH specific slice may be associated with a low bandwidth or high bandwidth. For example, when the number of user computing devices that are associated with an ODoH indicator is above a certain threshold, the network slice controller may increase the bandwidth associated with the OD0H specific slice. In embodiments where the number of user computing devices that are associated with an ODoH indicator are below a certain threshold, the network slice controller may decrease the bandwidth associated with the ODoH specific slice. Further, the ODoH specific slice may be terminated at any point, for example, by the network slice controller. It may be determined that there are no user computing devices associated with an ODoH indicator in a certain proximity of a particular base station or edge device associated with the ODoH specific slice. Or, the ODoH specific slice may be set to terminate at certain time intervals. In the embodiment in which an ODoH specific slice is terminated, the network resources associated with the ODoH specific slice may be allocated to any number of remaining slices of a network, or to the creation of a new network slice. In additional or alternative embodiments, the generation of an ODoH specific slice is not required to handle ODoH queries. ODoH queries may be handled based on determining that a user device is associated with an ODoH indicator.

Turning now to FIG. 4, a flow chart is provided for an additional or alternative method 400. At a first step 402, it is determined that a user computing device is associated with an ODoH indicator. At a second step 404, a DNS query is caused to transmit from the user computing device through an ODoH specific slice of a plurality of network slices.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A computerized method for providing secure network communications, the method comprising:
receiving a domain name system (DNS) query from a user computing device associated with a telecommunication network comprised of a plurality of network slices;
determining that the user computing device is associated with an Oblivious DNS Over HTTPS (ODOH) indicator; and
causing transmission of the DNS query through an ODOH specific slice of the plurality of network slices.

2. The computerized method of claim 1, wherein the ODOH specific slice is configured to transmit DNS queries to a network address translation (NAT) device configured to update an internet protocol address of the user computing device.

3. The computerized method of claim 2, wherein the NAT device is an edge computing device of the telecommunication network.

4. The computerized method of claim 1, wherein the ODOH specific slice is associated with a low bandwidth allocation.

5. The computerized method of claim 1, wherein the ODOH specific slice is associated with a high bandwidth allocation.

6. The computerized method of claim 1, further comprising:
resolving the DNS query through the ODOH specific slice; and
terminating the ODOH specific slice.

7. The computerized method of claim 6, further comprising:
allocating resources associated with the ODOH specific slice to a set of remaining slices of the plurality of network slices.

8. Computer-readable storage media having computer-executable instructions embodied thereon that, when executed by one or more processors, cause the one or more processors to:
determine that a user computing device is associated with an Oblivious DNS Over HTTPS (ODOH) indicator; and
cause transmission of a domain name system (DNS) query from the user computing device through an ODOH specific slice of a plurality of network slices.

9. The computer-readable storage media of claim 8, wherein the ODOH specific slice is configured to transmit DNS queries to a network address translation device configured to update an internet protocol address of the user computing device.

10. The computer-readable storage media of claim 8, wherein the network address translation device is an edge computing device of the telecommunication network.

11. The computer-readable storage media of claim 8, wherein the ODOH specific slice is associated with a low bandwidth allocation.

12. The computer-readable storage media of claim 8, wherein the ODOH specific slice is associated with a high bandwidth allocation.

13. The computer-readable storage media of claim 8, further comprising:
resolving the DNS query through the ODOH specific slice; and
terminating the ODOH specific slice.

14. The computer-readable storage media of claim 13, further comprising:
allocating resources associated with the ODOH specific slice to a set of remaining slices of the plurality of network slices.

15. A system for providing secure network communications, the system comprising:
a telecommunication network communicatively coupled to a user computing device;
one or more processors communicatively coupled to the telecommunication network, the one or more processors configured to:
receive a domain name system (DNS) query from the user computing device;
determine that the user computing device is associated with an Oblivious DNS Over HTTPS (ODOH) indicator; and
cause transmission of the DNS query through an ODOH specific slice of a plurality of network slices.

16. The system of claim 15, wherein the ODOH specific slice is configured to transmit DNS queries to a network address translation (NAT) device configured to update an internet protocol address of the user computing device.

17. The system of claim 15, wherein the NAT device is an edge computing device of the telecommunication network.

18. The system of claim 15, wherein the ODOH specific slice is associated with a low bandwidth allocation.

19. The system of claim 15, wherein the ODOH specific slice is associated with a high bandwidth allocation.

20. The system of claim 15, further comprising:
resolving the DNS query through the ODOH specific slice; and
terminating the ODOH specific slice.
